(19) United States
(12) Patent Application Publication
(10) Pub. No.: US 2017/0231721 A1
(43) Pub. Date: Aug. 17, 2017

(54) Automated Placement of Dental Orthodontic Attachments

(71) Applicants: Hadi Akeel, San Ramon, CA (US); George Wong, San Ramon, CA (US)

(72) Inventors: Hadi Akeel, San Ramon, CA (US); George Wong, San Ramon, CA (US)

(21) Appl. No.: 15/410,265

(22) Filed: Jan. 19, 2017

Related U.S. Application Data
(62) Division of application No. 62/280,449, filed on Jan. 19, 2016.

(51) Int. Cl. A61C 7/00; A61C 7/14; B29C 67/00; A61C 9/00; B33Y 10/00; B33Y 80/00; A61C 7/08; A61C 7/20

(52) U.S. Cl. CPC A61C 7/002; A61C 7/08; A61C 7/14; A61C 7/20; A61C 9/0046; B33Y 10/00; B33Y 80/00; B29C 67/0088; B29L 2031/753

(57) ABSTRACT

An automated procedure for correcting teeth misalignment in orthodontics using the steps of Generating a 3D digital model of a jaw having the misaligned teeth. Processing the 3D model to generate a corrective plan. Designing a set of corrective elements capable of applying corrective forces to the misaligned teeth through elastic forces. Designing a set of attachments that react to the corrective forces. identifying locations for applying the attachments to the surfaces of the teeth; Bonding the attachments to the identified locations. Rescanning the jaw of the patient and generating a final 3D model of the jaw with aligned teeth. Fabricating the corrective element in accordance with geometry of the final 3D model of the jaw. Applying the corrective element to the teeth wherein. Removing the attachments. A second 3D scan can be made to determine errors, and finite element analysis may be used to determine force vectors.

This application is related to, and claims priority to U.S. Provisional Patent application No. 62/280,449 filed Jan. 19, 2016. Application 62/280,449 is hereby incorporated by reference in its entirety. Related application Ser. No. 15/130,269 and 62/148,322 are also incorporated by reference in their entireties.

### BACKGROUND

Field of the Invention

The present invention relates generally to the field of dental orthodontic attachments and more particularly to a system and method for automated placement of dental orthodontic attachments.

Description of the Prior Art

History of Orthodontia

Dental Orthodontic treatment has been performed by dentists since the early 1800's, but the concept of straight teeth can be found as early as the ancient Egyptians when catgut were found around teeth in an early attempt to close gaps in teeth.

In the early 1900's, braces were dramatically different. Dentists would individually wrap bands tightly around each tooth. The bands would then be connected by a wire, and the wire could be adjusted to apply pressure to the teeth in hopes of slowly moving them into proper alignment.

It was not until the 1970's when modern day adhesive bracket technology came about. Dentists employ the use of enamel dental adhesives and orthodontic attachments that are applied to the tooth to create a mechanical means of moving teeth. Arch wires were utilized along with wire ties, and elastic ligatures to apply a force to each tooth.

In 2000, the company Align Technologies developed a method that combined 3D computer software technology and plastic aligners. The 3D software technology created many stages of a slow progression of moving the teeth back into a straight alignment. Each stage was represented by a different shaped clear aligner worn for a specified period of time which slowly shifted and moved the teeth closer to the next stage similar to how adhesive braces work.

Modern methods and attachments range from traditional brackets made of metal or ceramic brackets with a slot for a metal arch wire to composite attachments with a geometric shape that are engaged by clear aligners.

### The Biology of Orthodontic Tooth Movement

Orthodontic tooth movement is composed of three phases: initial tipping, lag phase and progressive tooth movement. The three biological phases of tooth movement are cited by:

Dolce C, Malone S J, Wheeler T T. Current concepts in the biology of orthodontic tooth movement. Semin. Orthod. 2002; 8:6-12.

Initial tipping occurs when a force (tipping) is applied to a crown of a tooth. The periodontal ligament (PDL) surrounding the surface of every root is compressed near the bone or alveolar marginal on the side toward which the tooth is moved. On the opposite side, the PDL is widened or is under tension. The amount of tipping is dependent on the PDL width, root length, anatomical configuration, force magnitude and periodontal health.

The lag phase represents a delay in movement, which reflects recruitment of cells and the establishment of a microenvironment that will allow the PDL and bone to remodel. This is when osteoclasts (bone absorbing cells) are recruited to the area and osteoblasts (cells that build bone) are activated. This lag phase can last from several days to several weeks.

The final phase of progressive tooth movement involves changing of the tissue around the tooth which creates a reduction of the applied stress terminating in tooth movement as the tooth moves into its final position until new forces are re-applied again. Bone resorption occurs in pressure areas, and bone formation occurs in areas of tension. The length of each phase is partially dependent on the amount of force applied.

### Mechanics of Orthodontic Tooth Movement

Controlled orthodontic movements of teeth are governed by bio-mechanical principles and forces. Each tooth in the mouth has a center of mass or resistance, to which if forces are applied through this point, the tooth will move linearly without any rotation. Factors that influence this are the length of the root, how many roots the tooth has, and the amount of supporting bone around each tooth.

Orthodontic forces are applied to teeth as vectors which contain magnitude and direction. Understanding the horizontal, vertical, and transverse components of that force allows the dentist to direct tooth movement a particular way. However, because each tooth is only partially exposed above the gum, orthodontic attachments do not typically apply the forces through the center of mass or the tooth, and rotation movements can occur unless some method is employed to counter these rotation forces causing only allowing linear movements. Dentists employ attachments which allow mostly linear movements while limiting rotation forces, unless they are also desired. See: Lindauer S J. The basics of orthodontic mechanics. Semin Orthod. 2001 March; 7(1):2-15.

The biologic cascade of events that ultimately results in bone remodeling and orthodontic tooth movement begins with the mechanical activation of an orthodontic appliance. The force systems produced by orthodontic appliances, consisting of both forces and moments, displace teeth in a manner that is both predictable and controllable. By varying the ratio of moment to force applied to teeth, the type of tooth movement experienced can be regulated by the orthodontist. Orthodontic appliances obey the laws of physics and can be activated to generate the desired force systems to achieve predetermined treatment goals for individual patients. Likewise, any orthodontic appliance can be analyzed to define the mechanical force systems it produces. Understanding the bio-mechanical principles underlying orthodontic appliance activations is essential for executing efficient and successful orthodontic treatment. Brackets and attachments are bonded to the surface of the teeth by an adhesive and act as anchor points for applying the corrective forces of a dental appliance such as a brace or an aligner.

Modern adhesive brackets made of metal or ceramic and utilize a slot which allows a wire to be placed into the slot and held in place by wire ties or elastic ligatures. This basic design of this appliance was developed in the mid-1900s. Modern designs of this bracket offer excellent torque and rotational control for the dentist.
See: http://www.americanortho.com/metal-standard-edgewise.html

For clear aligners, the attachment, button and shapes may be rectangular, square, circular, ellipsoidal or triangular, or other shape. The shape and orientation of a button is dictated by the purpose it serves (such as tooth rotation, translation, intrusion or extrusion)

The placement accuracy of either traditional pre-manufactured brackets, or forming composite attachments directly in the mouth, influences the success or failure of orthodontic treatment.

### See:

Andrews, L. F. (1976) The straight-wire appliance. Explained and compared. Journal of Clinical Orthodontics, 10, 174-195
Balut, N., Klapper, L., Sandrik, J. and Bowman, D. (1992) Variations in bracket placement in the preadjusted orthodontic appliances. American Journal of Orthodontics and Dentofacial Orthopedics, 102, 62-67.

Modern studies of tooth movement involve the use of finite element analysis. The bio-mechanics of tooth movement involve the applied stress to a tooth and subsequently the bone surrounding the tooth; attempts have been made in finite element analysis to model this process. The following authors have made an attempt to calculate and quantify simulated tooth movement using computer based programs.
Hayashia K, Araki Y, Uechi J, Hiroki Ohno H, Mizoguchi I. A novel method for the three-dimensional (3-D) analysis of orthodontic tooth movement calculation of rotation about and translation along the finite helical axis. J Biomech. 2002; 35:45-51. 2.
Jones M L, Hickman J, Middleton J, Knox J, Volp C. A validated finite element method study of orthodontic tooth movement in the human subject. J Orthod. 2001; 28:29-38.3.
Cattaneo P M, Dalstra M, Melsen B. The finite element method: a tool to study orthodontic tooth movement. J Dent Res. 2005; 84:428-433
   The Problem with Traditional Adhesive Brackets

Adhesive brackets of metal or ceramic design are adhered to the surface of each tooth to a specific location determined by the manufacturer and by the treating dentist. The tooth side of each bracket contains a textured surface to mechanically lock into the enamel by adhesives. Application of the bracket to the tooth involves the dentist applying the adhesive to the bracket manually estimating the volume of cement needed. The bracket is then placed into the desired position onto the tooth, and pressure is applied by the dentist to force an intimate contact with the tooth and lessen the chance of the bracket de-bonding and falling off the tooth. When this pressure is applied on the bracket, any excess adhesive flows out from the sides of the bracket and creates a flash of material which needs to be removed by the dentist. In this process of flash removal, the bracket can sometimes be moved from its ideal position and thus needs to be repositioned back into its ideal position.

3M Unitek has developed a bracket with pre-applied adhesive on the tooth side of the bracket. This bracket is called APC Plus. By controlling the volume of cement, the adhesive flash is virtually eliminated.

See:
http://solutions.3 m.com/wps/portal/3M/en US/orthodontics/Unitek/products/bonding-banding/direct-bond/APC-Flash-Free/

However, even with APC Plus brackets, the final position of the bracket is still manually determined by the dentist. This position will vary based on the visual acuity and manual dexterity of the dentist.

The Problem with Clear Aligners

Early methods with clear positional aligners such as Invisalign used a technique where the aligners were relied upon to position each tooth based upon the shape of the next stage aligner. As a result, the first placement of the aligner is an ill-fitting one forcing each mal-aligned tooth to move towards the position of its subsequent aligner. However, some teeth such as the canines which tend to have very long roots contain mostly tapered vertical surfaces. This geometric shape of the tooth did not allow good engagement of the tooth surface or the aligners to move the tooth into the predicted position. In addition, complex tooth movements like extrusion and rotation, create a challenge for the aligners without some positive engagement of the tooth.

This problem was examined and analyzed in a finite element analysis study by Gomez, Pena, Martinez, Giraldo, and Cardona in 2015. They studied the bodily movement of an upper canine with plastic aligners with and without composite attachments. They found that with composite attachments, complex forces can be generated to produce bodily movement of the tooth without rotation around the center of resistance.
See: Initial force systems during bodily tooth movement with plastic aligners and composite attachments: A three-dimensional finite element analysis. JP Gomez; F M Rena; V Martinez; DC Giraldoc; CI Cardona. Angle Orthodontist 2015; 85, 454-460.

As the 3D software technology improved, a series of geometric attachments were applied to the surface of some of the teeth in the software. This allowed the aligners to engage the teeth surfaces and the geometric attachments to create greater and more directed forces such as a tradition orthodontic bracket and wire.

Various dentists were sent aligners' templates having geometric attachment voids. At the first visit, the dentist was required to generate these attachments by filling the voids in the template with adhesive composite material and applying them to the teeth, thereby creating attachment buttons on the teeth. The following video shows the process of attaching the button to the teeth
See: https://www.youtube.com/watch?v=vuJ8 UZXh2E

However, because these attachments are generated directly on the patient's teeth, the dentist must accurately estimate the volume of material needed to create the attachment to avoid under-filling that can distort the shape of the attachment, or overfilling that extrudes a flash that must be removed with risk of displacing the attachment. Filling the geometric void with composite filling material can also generate user errors such as trapping a bubble while hand filling the material into the template, thereby not creating the ideal shape for proper engagement of the attachment with the aligner.

### Shortcomings of the Prior Art

The current practice of applying the attachment manually is generally inaccurate generating errors that cause the appliances not to fit as intended possibly undermining the success of the alignment process. With traditional braces brackets the patient must be attended to by the dentist several times to make adjustments that may partially correct the effect of the inaccuracies as well as tighten the braces for progressive correction. For the Clear aligners, any errors that may arise are not usually corrected and are reflected in the form of the tray set that is fabricated for the patient; their effect remains throughout the treatment program many times leading to a less than perfect outcome.

Furthermore, the design of the aligners is usually finalized based on the first scan of the patient's teeth on the assumption that when the buttons are applied, their location will remain as designed. This does not allow for the possibility that the buttons may not be applied correctly to the teeth. Errors may include voids in filling the button cavity that distorts its shape, or displacement of the button when excess filling is squeezed out or during flash removal.

Hence there is a need for a system and method that applies attachments with high accuracy and helps fabricate the aligners exactly to the target design regardless of attachment application accuracy.

### SUMMARY OF THE INVENTION

The automated method of Orthodontic attachment placement of the present invention includes a computer robotic vision system that images the teeth of a patient creating a 3D image of the treatment space. This was disclosed in our previous filing: “System and method for automating medical procedures” published as US 2015/0057675 A1. The dentist then plans the placement location of each attachment on a dental work station See: PCT/US15/42578. In addition, the software of the dental work station may also intelligently suggest the ideal position based on manufacturer recommendation, and/or collective clinical data collected and stored in memory. The software may also collect additional patient data such as x-rays, 3D scans of the teeth, bone, and root structures, surface scans of the teeth, to calculate with computer based programs such as finite element analysis the optimum position of a bracket.

The computed final position of the brackets can then be used to program robotic movements. The robot can place the brackets accurately into the stated position, and press the attachment with the precise amount of force to not allow adhesive flash to occur when the brackets are preloaded with adhesive (such as the 3M Unitek APC Plus brackets).

In the case of attachments for clear aligner, pre-fabricated geometrically shaped tooth colored attachments are attached to the teeth robotically in a manner similar to traditional brackets. The vision system then generates a 3D image of the teeth work space. The dentist uses the software program to generate the final position of the attachment. The attachments are then placed accurately into position by the robot. After the attachments are affixed to the tooth surface, the dentist has the option to rescan the dental work space to verify the accuracy of the attachments if needed. The clear aligners can then be fabricated and fitted to the patient. However, this scan is not able to verify to correct errors since it's after the fact. When the second scan is used to fabricate the aligners, the slight error, if it occurs, can be adapted to by the aligner to result in a good fit. If there is an error, and the aligner is fabricated to the original scan, even a slight error will cause an aligner misfit. Hence, the second scan is an improvement to correct the attachment errors. This process eliminates the errors potentially induced by limited human dexterity, visual acuity, and material handling.

1. The invention maintains the advantages of the clear aligners technique and benefits from a rigorous computerized approach of not only designing the holding buttons (also noted as attachments) and the retaining Tray (the clear aligner), but adding the ability to automate the fixation of the buttons to the teeth through robotics.
2. The invention also presents a method for the design of the retaining Tray adapted to a limited number of standardized button shapes, hence reducing cost and complexity and eliminating the uncertainty in having a best fit between the buttons and the tray.
3. The invention also presents a method for the design of the retaining Tray adapted to a button shape, further reducing cost of manufacturing
4. The invention also presents a method for the design of the retaining Tray adapted to a preinstalled set of buttons, and hence saves valuable dentist time and fully automates the design and installation process
5. The invention also presents a method for manufacturing the retaining trays where the trays are manufactured based on a 3D model of the teeth with pre-installed buttons, rather than having the buttons installed based on a pre-shaped pocket in the trays as is conventionally practiced in the prior art.
6. The invention presents a novel method for the design of the alignment implements and procedures based on the shape of the button and modifies the tray's mating surface to apply the desired alignment forces. In present prior art methods, the shape and orientation of the button is selected based on the desired correction forces, the invention modifies the mating surface on the tray to apply the desired forces. The invention design method eliminates errors associated with locating the buttons and inappropriate filling and placing of cavities; it also reduces cost and relieves the dentist of some of manual work.

### DESCRIPTION OF THE FIGURES

Attention is now directed to several drawings the illustrate features of the present invention.

FIG. 1 shows a flow chart of the preferred embodiment of the present invention.

FIG. 2 shows flow chart elements of alternate embodiments.

Several figures and illustrations have been provided to aid in understanding the present invention. The scope of the present invention is not limited to what is shown in the figures.

### DESCRIPTION OF THE PREFERRED EMBODIMENTS

In the field of Orthodontics, misaligned teeth are corrected by the application of forces and moments over a period of time to progressively cause the teeth to migrate towards a desired location, hence correcting the misalignment. The correction is normally done by affixing mechanical protrusions to the teeth and then bridging them by a fitted retainer that applies corrective forces and moments to the teeth. For braces, the retainer is a wire that attaches to brackets adapted to receiving and retaining a pre-strained wire. For clear aligners, the retainer is a shell Tray molded from clear polymer with pockets that are fitted snuggly over Buttons to apply the desired forces and moments.

The present invention includes the design of buttons for Tray applications and the process of designing and manufacturing the Trays. The invention applies buttons of pre-designed geometry to the teeth using a robot. The design utilizes 3D modeling of teeth and applies correction algorithms to decide the form of the bracket and the geometry of correction tray that, when mounted on the buttons, applies the correct forces and moments to progressively re-align the teeth. The invention utilizes various design techniques to decide on the forces necessary to make misalignment corrections and the location and orientation of the button surfaces that react to those forces.

The procedure according to a preferred embodiment includes the following steps:

1. The teeth are scanned by a digital scanner, and a 3D digital model is generated for the jaw with misaligned teeth. Digital scanners can include the Invisalign iTero; the 3M TruDef scanner; 3Shapes Trios; and, Cerec Sirona-connect.
2. The 3D digital model is input into an orthodontic design software program to calculate the forces and moments at selected teeth locations that are necessary to make the desired teeth corrections
3. An Attachment complement is designed with reactive surfaces that can support the desired forces at the desired locations and orientations.
4. A bonding adhesive is selected with desired adhesion and bio-compatibility properties
5. The Attachments are then prepared for mounting to the target teeth by one of two methods
a. Attachments are fabricated individually to the desired shape for each tooth, or
b. Buttons are selected from a set of pre-engineered, pre-fabricated and mass-produced forms that have the desired surfaces and strength.
6. The 3D model is then input into CAD design software to design the 3D model of a set of clear aligners, if the clear aligner process is selected for the patient.
7. The 3D model is sent to a molding, or digital printing facility to fabricate the aligner trays and send the full set of aligner tray complement to the dentist/patient.
8. The Attachments are then mounted by the adhesive bonding agent to their target teeth. The adhesive may be applied at the time of mounting or pre-applied to the buttons and preserved with a protective cover; the application is done by one of two methods
a. Manually, by the Dentist, or
b. Preferably robotically, such as described in Brachium patent application published as US 2015/0057675.
c. Robotically by mounting the Buttons on a dispensing tape within an applicator carried by the robot, where the tape is dispensed to the teeth surfaces and pressed to the surface by a pressing tool, and then the adhesive is cured by a curing light suitable for the adhesive such as ultra violet light.
9. The teeth, fitted with the attachments, are then optionally re-scanned, and a new 3D digital model is generated for the teeth and the attachments
10. The second scan is used validate accuracy and to fabricate new aligners if there is an error. If there is even a slight error, and the aligner is fabricated to the original scan, this error will cause an aligner misfit.
11. The 3D model is then input into the CAD design software to design the 3D model of a set of retaining Trays
12. The 3D model is sent to a molding, or digital printing, facility to fabricate the retaining Trays and send the full Tray complement to the patient.

Parts can be fabricated out of various materials. In particular:

a. Lithographic Digital Printing.

### b. 3D Printing.

c. Injection molding.

An alternative procedure is as follows for correcting teeth misalignments is as follows:

1. Applying a button to the teeth.
2. Scanning the teeth to generate a 3D geometric model of the surface of the misaligned teeth.
3. Using a virtual display to determine a desired final location of the teeth after alignment.
4. Using the 3D model to generate a finite element model of the teeth and supporting bone structure.
5. Using the finite element modeling and the parameters of the bone mechanics to determine the number of correction steps to correct the misalignment successively within the tolerance of the bone structure, where:
a. Each step introduces interference between the surfaces of the tray and the surfaces of the teeth and buttons.
b. Each step introduces the interference with a concentration at selected locations on the button as determined by the stress and strain analysis of the finite element model.
6. Modifying the 3D model into a set of models, each representing one of the correction steps that leads to the final teeth locations
7. Utilizing finite element analysis to determine the force vectors necessary to cause the desired migration of the teeth for each one of the correction steps.
8. Modifying the 3D model with button attachments that interfere with the teeth to cause the force vectors.
9. Applying finite element analysis to design the trays for each of the steps with position interference between the surface of the tray, the button attachments, and the surfaces of the teeth that strains the material of the tray such that it generates the desired force vectors.

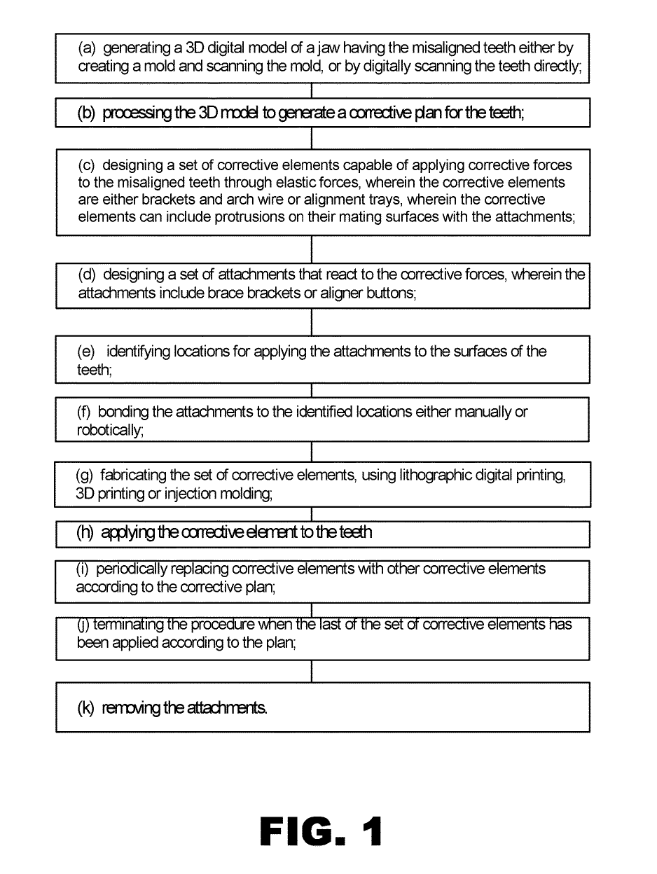

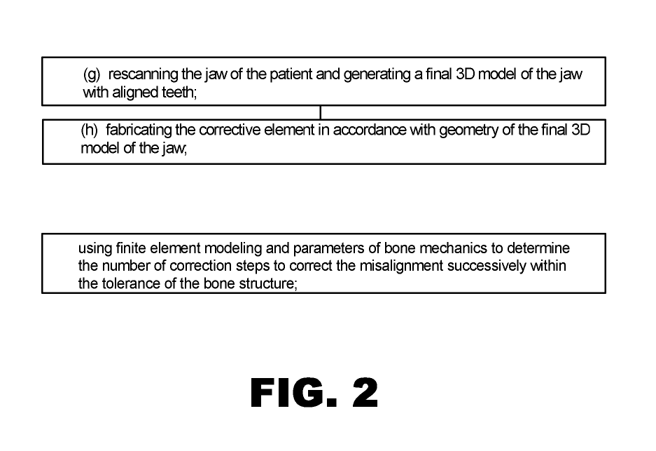

FIG. 1 shows a flow chart of the preferred embodiment of the present invention. FIG. 2 shows flow chart elements of alternate embodiments.

Note: The accuracy of applying the brackets, or attachments, by a robot is covered by our prior applications. Basically, “a robot manipulating tools to perform a dental procedure”.

Accordingly the present invention is based on the following contrast with the prior art:

| | |
|---|---|
| The prior art designs and builds | Prefabricated buttons, mass produced |
| their buttons in the tray. | and ready for application to the teeth |
| A template is used to mold and | No template needed |
| apply the buttons. | |
| Fabricate the trays based on a | The present invention fabricates the |
| scan that does not have the | trays based on a scan that includes the |
| buttons. | buttons. |
| Errors in cavity filling, | Button placement is avoided, benefits |
| squeezing and de-flashing. | from robotic accuracy & consistency |
| Dentist does manual work | Automated robotically, No manual |
| of button placement. | work for dentist |
| The buttons and the tray are | The buttons are independent of the |
| designed as a complementary | tray design. |
| set. | |
| The buttons are formed and | The button are pre-fabricated at much |
| applied at the time of the | lower cost and are readily available on |
| treatment with cost of | demand. |
| time and money added. | |
| | In an embodiment of the invention the |
| | tray is formed with knob protrusions |
| | that pressure the buttons at selected |
| | locations to generate controllable force |
| | vectors. |

The present invention includes stress and strain analysis software that determines the force vectors required, and adds pressure points (knobs) to the mating surface between the tray and the button that directs these forces as designed.

In summary, embodiments of the present invention include:

An automated procedure for correcting teeth misalignment in orthodontics wherein the corrective forces are applied by means of a polymeric, usually transparent, tray having teeth attachments with the steps of:
(a) generating a 3D digital model of the jaw having the misaligned teeth either by creating a mold and scanning the mold, or by digitally scanning the teeth directly;
(b) processing the 3D model to generate a corrective plan for the teeth;
(c) designing a set of corrective elements capable of applying corrective forces to the misaligned teeth through elastic forces, wherein the corrective elements are either brackets and arch wire or alignment trays, wherein the corrective elements can include protrusions on their mating surfaces with the attachments;
(d) designing a set of attachments that react to the corrective forces, wherein the attachments include brace brackets or aligner buttons;
(e) identifying locations for applying the attachments to the surfaces of the teeth;
(f) bonding the attachments to the identified locations either manually or robotically;
(h) fabricating the set of corrective elements, using lithographic digital printing, 3D printing or injection molding;
(i) applying the corrective element to the teeth wherein:
(aa) the corrective element is slightly forced to encapsulate the teeth and anchor to the attachments to generate the corrective forces through elastic forces in the use of clear aligners; or:
(bb) for traditional brackets, an arch wire is affixed as a component of the corrective element with wire ties or elastic ligatures;
(i) periodically replacing corrective elements with other corrective elements according to the corrective plan;
(j) terminating the procedure when the last of the set of corrective elements has been applied according to the plan;
(k) removing the attachments.

The corrective elements can include protrusions on their mating surfaces with the attachments to direct the forces as designed. The bonding the attachments can be attached to the identified locations manually or robotically.

In an alternate embodiment, the invention can include:

An automated procedure for correcting teeth misalignment in orthodontics wherein the corrective forces are applied by means of a polymeric, usually transparent, tray having teeth attachments with the steps of:
(a) generating a 3D digital model of a jaw having the misaligned teeth;
(b) processing the 3D model to generate a corrective plan;
(c) designing a set of corrective elements capable of applying corrective forces to the misaligned teeth through elastic forces;
(d) designing a set of attachments that react to the corrective forces;
(e) identifying locations for applying the attachments to the surfaces of the teeth;
(f) bonding the attachments to the identified locations;
(g) rescanning the jaw of the patient and generating a final 3D model of the jaw with aligned teeth;
(h) fabricating the corrective element in accordance with geometry of the final 3D model of the jaw;
(i) applying the corrective element to the teeth wherein:
(aa) the corrective element is slightly forced to encapsulate the teeth and anchor to the attachments to generate the corrective forces through elastic forces in the use of clear aligners;
(bb) for traditional brackets, affixing an arch wire as a component of the corrective element with wire ties or elastic ligatures;
(j) periodically replacing the corrective element with another of the set of corrective elements according to the corrective plan;
(k) terminating the procedure when the last of the set of corrective elements has been applied according to the plan;
(l) removing the attachments.

The 3D digital model can be created by generating a mold then scanning the mold digitally, or where the 3D digital model is created by digitally scanning the Jaw directly. The corrective elements can include protrusions on their mating surfaces with the attachments to direct the forces as designed. The set of attachments can be brace brackets or aligner buttons. The attachments can be bonded to the identified locations manually or robotically. The corrective element can be fabricated using lithographic digital printing, 3D printing or injection molding.

Finally, according to a third embodiment, the present invention includes:

A method for designing an alignment tray for correcting teeth misalignments with the following steps:
applying a button to the teeth;
scanning the teeth to generate a 3D geometric model of the surface of the misaligned teeth;
using a virtual display to determine a desired final location of the teeth after alignment;
using the 3D model to generate a finite element model of the teeth and supporting bone structure;
using finite element modeling and parameters of bone mechanics to determine the number of correction steps to correct the misalignment successively within the tolerance of the bone structure;
modifying the 3D model into a set of models each representing one of the correction steps that lead to the final teeth locations;
utilizing finite element analysis to determine the force vectors necessary to cause the desired migration of the teeth for each one of the correction steps;
   modifying the 3D model with button attachments that interfere with the teeth to cause the force vectors;
applying finite element analysis to design the trays for each of the steps with position interference between the surface of the tray, the button attachments, and the surfaces of the teeth that strains the material of the tray such that it generates the desired force vectors.

The procedure can use finite element modeling and parameters of bone mechanics to determine a number of correction steps that correct the misalignment successively within the tolerance of the bone structure so that each step introduces interference between the surfaces of the tray and the surfaces of the teeth and buttons.

Several descriptions and illustrations have been presented to aid in understanding the present invention. One with skill in the art will realize that numerous changes and variations may be made without departing from the spirit of the invention.

Each of these changes and variations is within the scope of the present invention.

We claim:

1. An automated procedure for correcting teeth misalignment in orthodontics wherein the corrective forces are applied by means of a polymeric, usually transparent, tray having teeth attachments comprising:
(a) generating a 3D digital model of a jaw having the misaligned teeth either by creating a mold and scanning the mold, or by digitally scanning the teeth directly;
(b) processing the 3D model to generate a corrective plan for the teeth;
(c) designing a set of corrective elements capable of applying corrective forces to the misaligned teeth through elastic forces, wherein the corrective elements are either brackets and arch wire or alignment trays, wherein the corrective elements can include protrusions on their mating surfaces with the attachments;
(d) designing a set of attachments that react to the corrective forces, wherein the attachments include brace brackets or aligner buttons;
(e) identifying locations for applying the attachments to the surfaces of the teeth;
(f) bonding the attachments to the identified locations either manually or robotically;
(g) fabricating the set of corrective elements, using lithographic digital printing, 3D printing or injection molding;
(h) applying the corrective element to the teeth wherein:
(aa) the corrective element is slightly forced to encapsulate the teeth and anchor to the attachments to generate the corrective forces through elastic forces in the use of clear aligners; or:
(bb) for traditional brackets, an arch wire is affixed as a component of the corrective element with wire ties or elastic ligatures;
(i) periodically replacing corrective elements with other corrective elements according to the corrective plan;
(j) terminating the procedure when the last of the set of corrective elements has been applied according to the plan;
(k) removing the attachments.

2. The automated procedure of claim 1 further comprising generating a mold then scanning the mold digitally.

3. The automated procedure of claim 1 further comprising digitally scanning the Jaw directly.

4. The automated procedure of claim 1 wherein the corrective elements are orthodontic brackets and arch wires.

5. The automated procedure of claim 1 wherein corrective elements are alignment trays.

6. The automated procedure of claim 1 wherein the corrective elements include protrusions on their mating surfaces with the attachments to direct the forces as designed.

7. The automated procedure of claim 1 wherein the set of attachments are brace brackets.

8. The automated procedure of claim 1 wherein the set of attachments are aligner buttons.

9. The automated procedure of claim 1 further comprising bonding the attachments to the identified locations manually.

10. The automated procedure of claim 1 further comprising bonding the attachments to the identified locations robotically.

11. An automated procedure for correcting teeth misalignment in orthodontics wherein the corrective forces are applied by means of a polymeric, usually transparent, tray having teeth attachments comprising the following steps:
(a) generating a 3D digital model of a jaw having the misaligned teeth;
(b) processing the 3D model to generate a corrective plan;
(c) designing a set of corrective elements capable of applying corrective forces to the misaligned teeth through elastic forces;
(d) designing a set of attachments that react to the corrective forces;
(e) identifying locations for applying the attachments to the surfaces of the teeth;
(f) bonding the attachments to the identified locations;
(g) rescanning the jaw of the patient and generating a final 3D model of the jaw with aligned teeth;
(h) fabricating the corrective element in accordance with geometry of the final 3D model of the jaw;
(i) applying the corrective element to the teeth wherein:
(aa) the corrective element is slightly forced to encapsulate the teeth and anchor to the attachments to generate the corrective forces through elastic forces in the use of clear aligners;
(bb) for traditional brackets, affixing an arch wire as a component of the corrective element with wire ties or elastic ligatures;
(j) periodically replacing the corrective element with another of the set of corrective elements according to the corrective plan;
(k) terminating the procedure when the last of the set of corrective elements has been applied according to the plan;
(l) removing the attachments.

12. The automated procedure of claim 11 wherein the 3D digital model is created by generating a mold then scanning the mold digitally.

13. The automated procedure of claim 11 wherein the 3D digital model is created by digitally scanning the Jaw directly.

14. The automated procedure of claim 11 wherein the corrective elements are orthodontic brackets and arch wires.

15. The automated procedure of claim 11 wherein corrective elements are alignment trays.

16. The automated procedure of claim 11 wherein the corrective elements include protrusions on their mating surfaces with the attachments to direct the forces as designed.

17. The automated procedure of claim 11 wherein the set of attachments are brace brackets.

18. The automated procedure of claim 11 wherein the set of attachments are aligner buttons.

19. The automated procedure of claim 11 further comprising bonding the attachments to the identified locations manually.

20. The automated procedure of claim 11 further comprising bonding the attachments to the identified locations robotically.

21. The automated procedure of claim 11 further comprising fabricating the corrective element using lithographic digital printing, 3D printing or injection molding.

22. A method for designing an alignment tray for correcting teeth misalignments comprising the following steps:
applying a button to the teeth;
scanning the teeth to generate a 3D geometric model of the surface of the misaligned teeth;
using a virtual display to determine a desired final location of the teeth after alignment;
using the 3D model to generate a finite element model of the teeth and supporting bone structure;
using finite element modeling and parameters of bone mechanics to determine the number of correction steps to correct the misalignment successively within the tolerance of the bone structure;
modifying the 3D model into a set of models each representing one of the correction steps that lead to the final teeth locations;
utilizing finite element analysis to determine the force vectors necessary to cause the desired migration of the teeth for each one of the correction steps;
modifying the 3D model with button attachments that interfere with the teeth to cause the force vectors;
applying finite element analysis to design the trays for each of the steps with position interference between the surface of the tray, the button attachments, and the surfaces of the teeth that strains the material of the tray such that it generates the desired force vectors.

23. The method of claim 22 further comprising using finite element modeling and parameters of bone mechanics to determine a number of correction steps that correct the misalignment successively within the tolerance of the bone structure so that each step introduces interference between the surfaces of the tray and the surfaces of the teeth and buttons.
